(19) United States
(12) Patent Application Publication
(10) Pub. No.: US 2006/0191094 A1
(43) Pub. Date: Aug. 31, 2006

(54) Windshield wiper assembly and method of manufacturing same

(76) Inventors: Janel L. Dace-Smith, Davisburg, MI (US); Dan Ehde, Ortonville, MI (US)

Correspondence Address: BLISS MCGLYNN, P.C., 2075 WEST BIG BEAVER ROAD, SUITE 600, TROY, MI, 48084, US

(21) Appl. No.: 11/344,279

(22) Filed: Jan. 31, 2006

Related U.S. Application Data
(60) Provisional application No. 60/651,545, filed on Feb. 9, 2005.

(51) Int. Cl. B60S 1/38

(52) U.S. Cl. 15/250.44; 29/428; 15/250.451; 15/250.452; 15/250.361

(57) ABSTRACT

The present invention is a windshield wiper assembly and a method of manufacturing the assembly that includes a wiping element having a length and a superstructure having length. The assembly further includes a vertebrae that connects the wiping element to the superstructure and a pair of end caps connected to the vertebrae. The superstructure, in combination with the wiping element, the vertebrae and the end caps, provide a first wiper blade assembly having a length similar to the wiping element. The superstructure, in combination with a wiping element and a vertebrae, provide a second wiper blade assembly having a length similar to the superstructure.

### CROSS REFERENCE TO RELATED APPLICATIONS

This application claims the benefit of U.S. provisional patent application entitled “Windshield Wiper Assembly and Method of Manufacturing Same,” having Ser. No. 60/651,545, and filed on Feb. 9, 2005.

### BACKGROUND OF THE INVENTION

1. Field of the Invention

The present invention relates, generally, to windshield wiper assemblies. More specifically, the present invention relates to a windshield wiper assembly that may be varied in length and a method of manufacturing same.

2. Description of the Related Art

Windshield wiper assemblies known in the related art include a wiping element that contacts the surface to be wiped and some type of superstructure that supports the wiping element. Windshield wiper assemblies are connected to a wiper arm, which is pivotally driven to impart a reciprocating motion to the windshield wiper assembly across the surface to be wiped, namely a windshield, rear window, or headlight. Since the surface area to be wiped can vary, windshield wiper assemblies are offered in several lengths to accommodate this variance. For example, windshield wiper assembly lengths are offered in one-inch increments. However, each specific length of windshield wiper assembly is constructed from components having specific dimensions designed to accommodate the desired length of windshield wiper assembly. Thus, a majority, if not all, of the components of a windshield wiper assembly are used exclusively for a particular length of windshield wiper assembly and cannot be employed to assemble a windshield wiper assembly having a different length.

By way of example, one type of windshield wiper assembly commonly employed in the related art is a “tournament” style wiper assembly. One component of a tournament style wiper assembly is a superstructure. The superstructure includes a primary lever that is coupled to the wiper arm, two or more secondary levers pivotally mounted to the primary lever, and a series of two or more tertiary levers pivotally mounted the secondary levers. The dimensions of all or at least some of the levers of the superstructure must be changed to provide tournament-style wiper assemblies of different lengths. Changing the dimensions of these levers to provide different lengths of windshield wiper assemblies requires machine retooling or changing dies and/or mold cavities, which increases manufacturing costs by way of machine/line downtime and associated labor.

On the other hand, manufacturers are continually challenged to implement cost-effective methods of manufacturing in order to produce a commercially viable product line that satisfies consumer needs while maintaining low manufacturing costs. This challenge is more pronounced for wiper assemblies with limited markets, such as those used in Off-Road Vehicles (“ORVs”), heavy industrial vehicles, or those designed for specific climate conditions. One type of climate-specific windshield wiper assembly is commonly referred to as a, “winter” windshield wiper assembly, which is designed to perform in conditions of snow, ice, freezing rain and the like. In these limited markets, it is often cost-prohibitive to provide lengths of windshield wiper assemblies in one-inch increments.

Accordingly, some manufacturers may choose to supply such limited market wiper assemblies in two-inch increments as opposed to the preferred one-inch size. While cost-effective for the manufacturer, this approach has certain disadvantages. For example, some consumers who desire to employ a winter windshield wiper assembly may have to choose between a reduced or increased length winter wiper assembly relative to the length of their standard windshield wiper assembly supplied by OEMs. Employing a smaller length windshield wiper assembly reduces the wiped surface area, which may result in reduced visibility. Conversely, employing a longer length windshield wiper assembly can increase the wiped surface area, but the windshield wiper assembly may encounter interference with structure adjacent the surface to be wiped, such as the A-pillar that borders the windshield. This interference impairs the windshield wiper assembly's ability to effectively wipe the desired surface area and can result in mechanical failure of the wiper assembly due to repeated collisions with surrounding structure.

Thus, there is a need in the art for a windshield wiper assembly that meets consumer needs yet is cost-effective to manufacture in different lengths, preferably in one-inch increments. Specifically, there is a need in the art for a windshield wiper assembly that may be varied in length. There is also a need in the art for a method of manufacturing a windshield wiper assembly that reduces costs associated with providing windshield wiper assemblies in one-inch increments by employing components that produce at least two different lengths of windshield wiper assemblies.

### SUMMARY OF THE INVENTION

The present invention overcomes many limitations and disadvantages in the related art in windshield wiper assemblies, as well as the method of manufacturing a windshield wiper assembly. To this end, the windshield wiper assembly of the present invention includes a wiping element having a predetermined length and a superstructure having predetermined length different than the wiping element. The windshield wiper assembly further includes a vertebrae that connects the wiping element to the superstructure and a pair of end caps, such that the combined length of the end caps and superstructure is substantially similar to the length of the wiping element, thereby enabling a single superstructure to be employed for use in connection with windshield wiper assemblies having at least two different lengths.

The method of manufacturing a windshield wiper assembly according to present invention further includes the steps of attaching a vertebrae to a wiping element having a predetermined length. A superstructure having a predetermined length different than the wiping element is then attached to the wiping element as facilitated by the vertebrae. A pair of end caps are subsequently secured to the vertebrae where the combined length of the end caps and superstructure is substantially similar to the predetermined length of the wiping element.

Thus, one advantage of the present invention is that it provides a windshield wiper assembly having a superstructure suitable for use in connection with at least two different length windshield wiper assemblies.

Another advantage of the present invention is that it provides a method of manufacturing a windshield wiper assembly that reduces the need for machine re-tooling and/or changing molds to manufacture components for different lengths of windshield wiper assemblies.

Yet another advantage of the present invention is that it provides a windshield wiper assembly that is mechanically efficient and cost effective to manufacture, and that is specifically designed to increase the variety of limited market windshield wiper assembly lengths available to consumers to harmonize the lengths of limited market windshield wiper assemblies with the lengths of standard windshield wiper assemblies employed by OEMs in the related art.

Other objects, features and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of the front of an automotive vehicle having a pair of windshield wiper assemblies pivotally mounted for reciprocal movement across the windshield of the vehicle.

FIG. 2 is a partially assembled view of the wiper assembly according to an embodiment of the present invention.

FIG. 2A is an enlarged fragmentary view of the vertebrae and end cap of the windshield wiper assembly according to an embodiment of the present invention.

FIG. 3 is a perspective view of the wiper assembly according to an embodiment of the present invention.

FIG. 4 is a perspective view of a climate-specific wiper assembly according to another embodiment of the present invention.

### DETAILED DESCRIPTION OF THE PREFERRED EMBODIMENT(S)

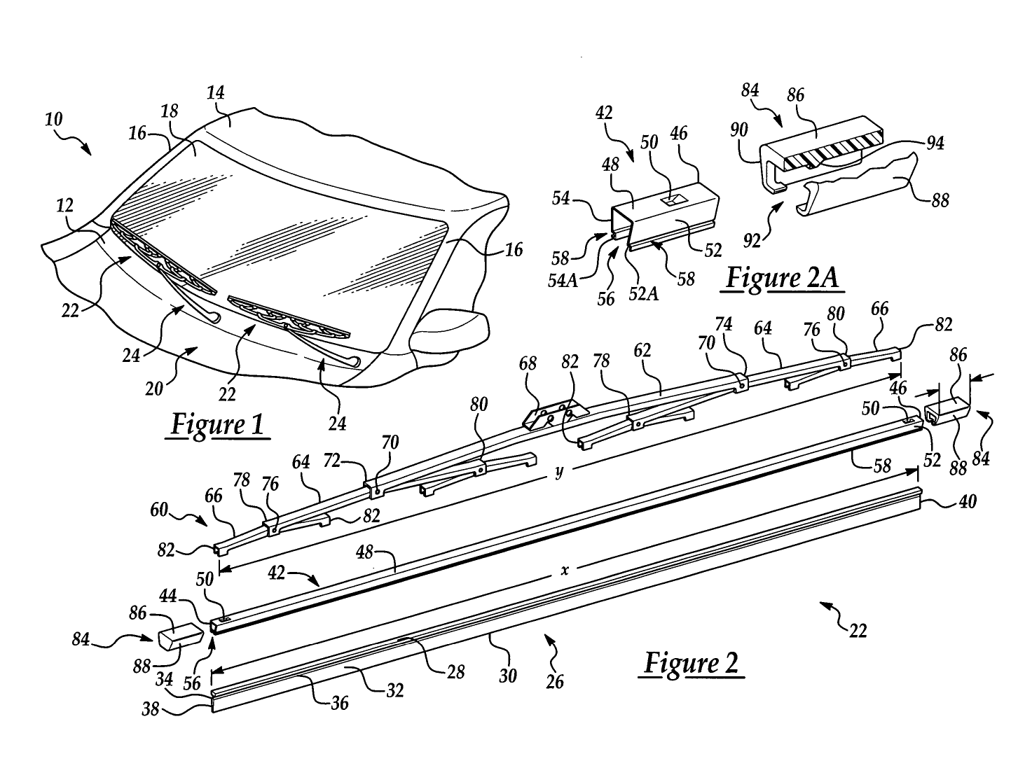

Referring now to the figures, where like numerals are used to designate like structure, a portion of a vehicle is illustrated at 10 in FIG. 1. The vehicle body includes a cowl 12, a roof 14, and a pair of laterally spaced front or “A” pillars 16 extending between the roof 14 and the cowl 12. The A-pillars 16, roof 14, and cowl 12 cooperate to define a generally rectangular perimeter, which supports a curved or “swept back” windshield 18.

A windshield wiper system is generally indicated at 20 in FIG. 1 and is employed to clean the glass windshield 18. The windshield wiper system 20 includes a pair of windshield wiper assemblies, generally indicated at 22, which correspond to the driver and passenger side of the vehicle 10. Each windshield wiper assembly 22 is carried by a corresponding wiper arm assembly, generally indicated at 24. The wiper arm assembly 24 includes an attachment member (not shown but generally known in the art) adapted to operatively engage a windshield wiper assembly 22. An electrical motor (not shown but generally known in the art) is employed to power the wiper system 20 to move the windshield wiper assemblies 22 in an oscillating manner across the surface of the windshield 18.

While the windshield wiper assembly 22 illustrated in FIG. 1 is shown in connection with the front windshield 18 of the vehicle 10, those having ordinary skill in the art will appreciate that windshield wiper assemblies 22 may be employed in other areas of a vehicle 10, such as a rear window (not shown) or a head lamp (not shown) that employ a wiper system 20. Thus, it will be understood that the present invention is not limited for use solely in connection with wiper arm assemblies 24 and windshield wiper assemblies 22 adapted for use on a vehicle's windshield 18, but for use in all applications where wiper arm assemblies 24 and wiper assemblies 22 are employed.

The wiper assembly 22 illustrated in the figures includes an elongate wiping element, generally indicated at 26, to contact the surface of the vehicle 10 to be wiped, namely the windshield 18. The elongate wiping element 26 includes an upper section 28 and a lower section 30 having opposed sides 32, 34. The upper section 28 and lower section 30 are divided by longitudinally extending slots 36 disposed on the side surfaces 32, 34 of the wiping element 26. The elongate wiping element 26 further includes opposed lateral ends 38, 40 that define a predetermined length (X) of the wiping element 26. The predetermined length (X) typically corresponds to a specific portion of the surface area to be wiped and therefore varies in length depending on the desired application. The elongate wiping element 26 is constructed from a flexible material such as rubber, silicone or other polymer and is manufactured by an extruding process, which enables the length of the wiping element 26 to be easily adjusted without a substantial increase to manufacturing expense.

Referring to FIGS. 2 and 2A, the windshield wiper assembly 22 further includes a vertebrae, generally indicated at 42. The elongate vertebrae includes opposed terminal ends 44, 46 that define a predetermined length substantially similar to the elongate wiping element 26. The vertebrae 42 further includes a base 48 having recesses 50 adjacent each terminal end 44,46 and two legs 52, 54 depending from the base 48. Each of the legs 52, 54 includes a tab 52a, 54a that is turned inward, toward the other. Further, the base 48 and legs 52, 54 form an elongate track, generally indicated at 56, that receives the upper section 28 of the wiping element 26. The legs 52, 54 further include an elongate groove 58 to receive a portion of the superstructure, as will be described in greater detail below.

The elongate vertebrae 42 is constructed from a polymer having a semi-rigid and resilient quality when cured and manufactured through an extrusion process which, like the elongate wiping element 26, enables the predetermined length to be easily adjusted without a substantial increase to manufacturing expense. However, those having ordinary skill in the art will appreciate that the vertebrae 42 may be constructed from other materials such as rubber, aluminum, or steel and manufactured by other processes such as injection molding, casting or machining.

The windshield wiper assembly 22 further includes a superstructure, generally indicated at 60. The superstructure 30 includes a “tournament” style configuration having a predetermined length (Y) less than the predetermined length (X) of the elongate wiping element 26. The tournament style superstructure 60 includes a primary lever 62, two secondary levers 64, and a series of two or more tertiary levers 66. The primary lever 62 further includes a coupler 68 to engage the attachment member of a wiper arm assembly 24. The secondary levers 64 are articulated to the primary lever 62 at pivot points 70 located at the opposed, lateral ends 72, 74 of the primary lever 62. Similarly, the tertiary levers 66 are each articulated to the secondary levers 64 at pivot points 76 located at the opposed lateral ends 78, 80 of the secondary levers 64. The tertiary levers 66 include clawed opposed lateral ends 82 that are adapted to engage the elongate grooves 58 of the vertebrae 42 and thereby facilitating attachment of the wiping element 26 to the superstructure 60.

As illustrated in FIGS. 1 and 2, the superstructure 60 includes one primary lever 62, two secondary levers 64 and four tertiary levers 66, but those having ordinary skill in the art will appreciate that the superstructure 60 may include any number of secondary and tertiary levers without departing from the scope of the invention. As is commonly known in the art, the levers of the superstructure 60 are manufactured to specific dimensions from a metal material such as aluminum or steel and subsequently assembled to form a superstructure 60 having a predetermined length (Y).

In order to provide different lengths of windshield wiper assemblies 22, previous manufacturing methods adjusted the length of one or all of the components 26, 56, and/or 60 of a windshield wiper assembly 24. Since components such as the vertebrae 42 and the wiping element 26 are generally cut to a predetermined length from an extruded elongate stock, providing different predetermined lengths simply involves adjusting the cutting line, resulting in a nominal cost increase, if any. However, adjusting the dimensions of the superstructure 60 to provide a different length windshield wiper assembly 22 involves changing the dimensions of all or some of the levers 62, 64, and 66. Changing these dimensions requires re-tooling the machine or changing the die and/or mold cavity, which is costly and time consuming, especially considering that the lengths of wiper assemblies preferably occur in only one-inch increments.

To reduce the need for re-tooling or changing molds in order to provide different lengths of wiper assemblies 22, the present invention further includes end caps, generally indicated at 84, having a predetermined length less than the elongate wiping element 26, such that the combined length of the end caps 84 and the superstructure 60 is substantially similar to the predetermined length (X) of the wiping element 26. By way of example, where a wiping element 26 is eighteen inches in length and the length of a superstructure 60 is seventeen inches, the length of the end caps 84 are one half inch each. In this manner, one superstructure 60 having a predetermined length (Y) may be employed to provide at least two different lengths of windshield wiper assemblies 22; one length without the end caps 84 and another with the end caps 84. Accordingly, the end caps 84 reduce the need to re-tool machinery or change molds to provide for different lengths of windshield wiper assemblies 22, thereby reducing the cost associated with manufacturing windshield wiper assemblies 22 in one-inch increments.

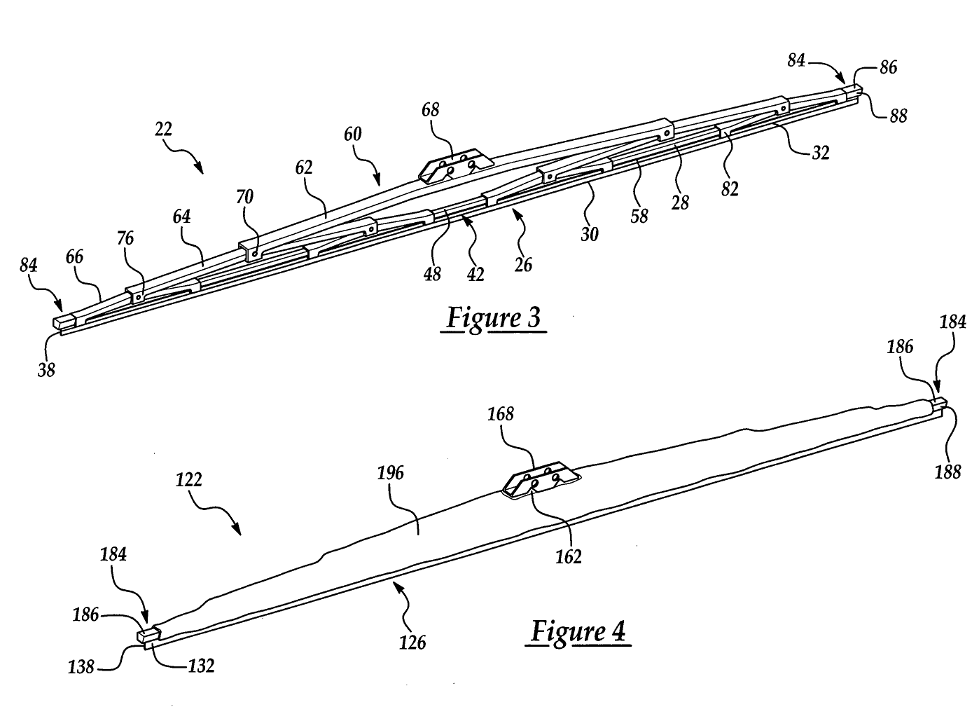

As best shown in FIGS. 2-4, the end caps 84 include a top surface 86 and downwardly converging side surfaces 88, 90 depending therefrom. The top surface 86 and side surfaces 88, 90 form a sleeve, generally indicated at 92, to receive the opposed terminal ends 44, 46 of the vertebrae 42. The end caps 84 further include a flange 94 within the sleeve 92 to engage the recesses 50 of the vertebrae 42, thereby locking the end caps 84 to the vertebrae 42. Thus, the elongate vertebrae 42 facilitates formation of a complete windshield wiper assembly 22 by engaging the wiping element 26 to the superstructure 60 as well as engaging the end caps 84. While the vertebrae 42 shown in the figures is substantially U-shaped, those having ordinary skill in the art will appreciate that the vertebrae 42 may be constructed to assume several different shapes to accomplish its intended function. By way of example, the vertebrae 42 may be a piece or pieces of resilient elongate flat stock that sandwich the wiping element 26 and is suitable for attachment to the superstructure 60 and end caps 84. The end caps 84 are constructed from a polymer and manufactured by an extrusion process. However, those having ordinary skill in the art will appreciate that the end caps 84 may be constructed from a rubber compound or metal such as aluminum and may be manufactured by other processes such as injection molding, casting, or machining. Further, the ability of the end caps 84 to provide for a single length superstructure 60 to be employed for use in at least two windshield wiper assemblies 22 is particularly advantageous with respect to limited market windshield wiper assemblies 22, which typically are available in only lengths of two inch increments.

Another embodiment of the windshield wiper assembly of the present invention is generally indicated at 122 in FIG. 4, where like numerals, increased by 100 with respect to the embodiment of the invention illustrated in FIGS. 1-3, are used to designate like structure. The windshield wiper assembly 122 of the present invention as shown in FIG. 4 is substantially similar to the windshield wiper assembly 22 shown in FIGS. 1-3, including a similar superstructure 160, vertebrae 142, wiping element 126, and end caps 184. However, windshield wiper assembly 122 shown in FIG. 4 is a limited market windshield wiper assembly. Specifically, the windshield wiper assembly 122 shown in FIG. 4 is climate-specific and commonly referred to as a “winter” wiper assembly.

Winter windshield wiper assemblies 122 typically include a jacket 196 that covers the superstructure 160 to prevent the pivot points 170, 176 between the primary, secondary and tertiary levers 162, 164, and 166 from freezing in a fixed position. The jacket 196 is constructed from a sheet of polymer or rubber, which is then wrapped around the superstructure 160 and secured within the elongate track 156, between the legs 152, 154 of the vertebrae 142 and the upper section 128 of the wiping element 126. The jacket 196 may optionally be riveted to the primary lever 162 adjacent the coupler 168. Those having ordinary skill in the art will appreciate that the jacket 196 may be constructed from any material capable of protecting the pivot points 170, 176 from the elements while enabling same to pivot without restriction.

The wiper assembly 22, 122 of the present invention is manufactured according to a method that will be described with reference to the windshield wiper assembly illustrated in FIGS. 1-3. Using this method, an extruded, semi-flexible vertebrae 42 is attached to an elongate wiping element 26 including opposed lateral ends 38, 40 that define a predetermined length (X). Particularly, the upper section 38 of the elongate wiping element 26 is received within the elongate track 56 of the vertebrae 42. A superstructure 60 having predetermined length (Y) less than the predetermined length (X) of the elongate wiping element 26 is attached to the vertebrae 42. The superstructure 60 includes tertiary levers 66 having clawed lateral ends 82, that engage the grooves 58 along the legs 52, 54 of the vertebrae 42. End caps 84 are subsequently secured to the terminal ends 44, 46 of the vertebrae 42 such that the combined length of the superstructure 60 and the end caps 84 is substantially similar to the predetermined length (X) of the elongate wiping element 26. Particularly, the end caps 84 include a flange 94 disposed within the sleeve 92 defined by the top and side surfaces 86, 88 and 90 of the end caps 84 that engage recesses 50 within the base 48 of the vertebrae 42.

Where the windshield wiper assembly 124 is climate-specific, such as the winter wiper assembly illustrated in FIG. 4, the method of manufacturing includes the additional step of securing the jacket 196 to the wiper assembly 122. Specifically, a portion of the jacket 196 is inserted within the elongate track 156 of the vertebrae 142 prior to receiving the upper section 128 of the elongate wiping element 126. In this manner, a portion of the jacket 196 is secured between the elongate wiping element 126 and the interior of the legs 152, 154 of the vertebrae 142, thereby protecting the superstructure 160 from the elements. Additionally, the method of manufacturing may also include riveting the jacket 196 to the primary lever 162 adjacent the coupler 168.

The present invention provides a superstructure 60, 160 suitable for use within at least two different lengths of windshield wiper assemblies 22, 122. Accordingly, the present invention improves the availability of wiper assemblies 22, 122 having different lengths, particularly providing windshield wiper assemblies 22, 122 in one-inch increments. Further, the present invention provides end caps 84, 184 having a predetermined length that cooperates with the length (Y) of the superstructure 60, 160 to accommodate a wiping element 26, 126 having a predetermined length (X) greater than the superstructure 60, 160. Accordingly, the present invention reduces the need for manufacturing superstructures 60, 160 having different dimensions to provide for windshield wiper assemblies 22, 122 of different lengths extending in one-inch increments. Further, the present invention provides an end cap 84, 184 and superstructure 60, 160 suitable for use in providing at least two different lengths of limited market windshield wiper assemblies, such as climate-specific windshield wiper assemblies. Accordingly, the present invention increases the available lengths of climate-specific wiper assemblies 122 to lengths of one-inch increments, thereby harmonizing the available lengths of climate-specific windshield wiper assemblies 122 with the lengths of standard windshield wiper assemblies employed by OEMs. Further, the present invention includes a method of manufacturing a windshield wiper assembly 22, 122 that attaches a superstructure 60, 160 of a predetermined length (Y) to a wiping element 26, 126 of a predetermined length (X) greater than that of the superstructure 60, 160 to provide for at least two different lengths of windshield wiper assemblies 22, 122. Accordingly, the present invention reduces the need for machine retooling and changing dies and/or mold cavities to manufacture windshield wiper assemblies 22, 122 of different lengths. Further, the present invention provides a method of manufacturing a windshield wiper assembly 22, 122 that attaches an end cap 84, 184 to the vertebrae 42, 142 of a windshield wiper assembly 22, 122 to provide at least two different lengths of wiper assemblies 22, 122. Accordingly, the present invention reduces machine and labor downtime, thus providing a mechanically efficient and cost effective windshield wiper assemblies 22, 122 of different lengths.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A windshield wiper assembly having a superstructure for use in connection with providing wiper assemblies of various lengths, said windshield wiper assembly comprising:
a wiping element including opposed lateral ends that define a predetermined length therebetween, said wiping element adapted to contact a surface to be wiped;
a superstructure having predetermined length different than the predetermined length of said wiping element, said superstructure adapted to facilitate movement of said wiping element across a surface to be wiped;
a vertebrae adapted to facilitate attachment between said wiping element and said superstructure, said vertebrae having opposed terminal ends that define a predetermined length therebetween that is substantially similar to the predetermined length of said wiping element; and
a pair of end caps operatively engaged to said terminal ends of said vertebrae that cooperate with said superstructure to provide a combined length no less than the predetermined length of said wiping element,
wherein said superstructure is adapted for use in combination with said wiping element, said vertebrae and said end caps to provide a first wiper blade assembly having a predetermined length substantially similar to the predetermined length of said wiping element as well as for use in combination with a wiping element and a vertebrae to provide a second wiper blade assembly having a predetermined length substantially similar to the predetermined length of said superstructure.

2. The wiper assembly as set forth in claim 1 wherein said vertebrae further includes a base and two legs depending therefrom, each of said legs having a tab that is turned inward toward to other, said base and said legs cooperating to define a track adapted to operatively receive a portion of said wiping element.

3. The wiper assembly as set forth in claim 2 wherein said wiping element further includes an upper section and a lower section defined by slots that extend between said opposed lateral ends and along opposite sides of said wiping element, said upper section adapted to operatively engage said track and said slots adapted to operatively receive said tabs to provide attachment between said wiping element and said vertebrae.

4. The wiper assembly as set forth in claim 2 wherein each of said legs further include a groove disposed opposite said tabs and adapted to operatively receive a portion of said superstructure.

5. The wiper assembly as set forth in claim 1 wherein said superstructure includes a primary lever operatively connected to said vertebrae and a coupler attached to said primary lever, said coupler adapted to operatively engage a wiper arm.

6. The wiper assembly as set forth in claim 5 wherein said superstructure further includes at least one secondary lever pivotally attached to said primary lever and at least one tertiary lever pivotally attached to said secondary lever, said tertiary lever having opposed lateral ends that are adapted to engage a portion of said vertebrae to facilitate operative connection between said vertebrae and said primary lever.

7. The wiper assembly as set forth in claim 1 wherein said end caps include a top surface and downwardly converging side surfaces depending therefrom, said top surface and said side surfaces cooperate to define a sleeve adapted to receive said opposed terminal ends of the vertebrae.

8. The wiper assembly as set forth in claim 7 wherein said end caps further include a flange depending from said top surface between said side surfaces and said vertebrae includes a pair of recesses adjacent said terminal ends, said flanges adapted to operatively engage said recesses of said vertebrae to thereby secure said end caps to said vertebrae.

9. The wiper assembly further comprising a flexible jacket adapted to cover said superstructure for protection from adverse weather conditions, said jacket is operatively secured between said wiping element and said vertebrae.

10. A method of manufacturing a windshield wiper assembly having a superstructure for use in connection with providing wiper assemblies of various lengths, said method comprising the steps of:
attaching a semi-flexible wiping element having opposed lateral ends that define a predetermined length therebetween to a semi-flexible vertebrae having opposed terminal ends that define a predetermined length therebetween that is substantially similar to the predetermined length of the wiping element;
attaching a superstructure having a predetermined length different than the predetermined length of the wiping element to the vertebrae; and
securing a pair of end caps to the opposed terminal ends of the vertebrae where the sum of the length of the end caps and the superstructure is no less than the predetermined length of the wiping element such that the superstructure is adapted for use in connection with the wiping element, the vertebrae and the end caps to provide a first wiper blade assembly having a predetermined length substantially similar to the predetermined length of the wiping element as well as for use in connection with a wiping element and a vertebrae to provide a second wiper blade assembly having a predetermined length substantially similar to the predetermined length of the superstructure.

11. The method as set forth in claim 10 wherein the step of attaching a semi-flexible vertebrae to a wiping element further includes the steps of:
extruding a vertebrae from a polymer material so as to define a vertebrae having a base and two legs depending therefrom, each of the legs having a tab that is turned inward toward to other, the base and the legs cooperating to define a track that is adapted to operatively receive a portion of the wiping element;
extruding a wiping element from a polymer material so as to define a wiping element having an upper section and a lower section defined by slots that extend between the opposed lateral ends; and
inserting the upper section within the track of the vertebrae such that the slots operatively receive the tabs.

12. The method as set forth in claim 11 further comprises the steps of:
forming a flexible jacket adapted to cover the superstructure;
covering the superstructure with the flexible jacket for protection from adverse weather conditions;
attaching the flexible jacket to the wiper assembly inserting a portion of the flexible jacket into the track of the vertebrae; and
inserting the upper section of the wiping element into the track of the vertebrae such that a portion of the flexible jacket is secured between the track and the upper section.

13. The method as set forth in claim 10 wherein the step of attaching a superstructure to the semi-flexible vertebrae further includes the steps of:
extruding a vertebrae from a polymer material so as to define a vertebrae having a base and two legs depending therefrom, each of the legs having a groove to operatively receive a portion of the superstructure;
fabricating a superstructure to include a primary lever and a coupler attached to the primary lever to operatively engage a wiper arm and further having at least one secondary lever pivotally attached to the primary lever and at least one tertiary lever pivotally attached to the secondary lever, where the tertiary lever includes opposed lateral ends; and
inserting a portion of the opposed lateral ends of the tertiary lever into the groove of the vertebrae to provide a connection between the vertebrae and the primary lever.

14. The method as set forth in claim 10 wherein the step of securing a pair of end caps to the opposed terminal ends of the semi-flexible vertebrae further includes the steps of:
forming end caps so as to define a top surface and downwardly converging side surfaces depending therefrom such that the top surface and the side surfaces cooperate to define a sleeve and to define a flange that depends from the top surface between the side surfaces;
forming the vertebrae to include a pair of recesses adjacent the terminal ends; and
inserting the terminal ends of the vertebrae into the sleeve of the end caps such that the flange disposed within the end cap operatively engage the recess of the vertebrae to thereby secure the end caps to the vertebrae.

15. A windshield wiper assembly that provides wiper assemblies having various lengths, said windshield wiper assembly comprising:
a wiping element including opposed lateral ends that define a predetermined length therebetween, said wiping element adapted to contact a surface to be wiped;
a superstructure having predetermined length different than the predetermined length of said wiping element, said superstructure adapted to facilitate movement of said elongate wiping element across a surface to be wiped;
a vertebrae adapted to facilitate attachment between said wiping element and said superstructure, said vertebrae having opposed terminal ends and a recess adjacent thereto, said terminal ends define a predetermined length therebetween that is substantially similar to the predetermined length of said wiping element;
a flexible jacket adapted to cover said superstructure for protection from adverse weather conditions, a portion of said jacket is disposed between said wiping element and said vertebrae for attachment to said assembly; and
a pair of end caps each having a flange adapted to operatively engage said recesses of said vertebrae to thereby secure said end caps to said vertebrae, said end caps cooperate with said superstructure to provide a combined length no less than the predetermined length of said wiping element;
wherein said superstructure is adapted for use in combination with said wiping element, said vertebrae and said end caps to provide a first wiper blade assembly having a predetermined length substantially similar to the predetermined length of said wiping element as well as for use in combination with a wiping element and a vertebrae to provide a second wiper blade assembly having a predetermined length substantially similar to the predetermined length of said superstructure.

16. The wiper assembly as set forth in claim 15 wherein said vertebrae further includes a base and two legs depending therefrom, each of said legs having a tab that is turned inward toward to other, said base and said legs cooperate to define a track adapted to operatively receive a portion of said wiping element.

17. The wiper assembly as set forth in claim 16 wherein said wiping element further includes an upper section and a lower section defined by slots that extend between said opposed lateral ends and along opposite sides of said wiping element, said upper section adapted to operatively engage said track and said slots adapted to operatively receive said tabs to provide attachment between said wiping element and said vertebrae.

18. The wiper assembly as set forth in claim 16 wherein each of said legs further include a groove disposed opposite said tabs and adapted to operatively receive a portion of said superstructure.

19. The wiper assembly as set forth in claim 15 wherein said superstructure includes a primary lever having a coupler adapted to operatively engage a wiper arm, at least one secondary lever pivotally attached to said primary lever and at least one tertiary lever pivotally attached to said secondary lever, said tertiary lever having opposed lateral ends that are adapted to engage a portion of said vertebrae to facilitate operative connection between said vertebrae and said superstructure.

20. The wiper assembly as set forth in claim 15 wherein said include a top surface and downwardly converging side surfaces depending therefrom, said top surface and said side surfaces cooperate to define a sleeve adapted to receive said opposed terminal ends of the vertebrae.
